(19) United States
(12) Patent Application Publication
(10) Pub. No.: US 2008/0029316 A1
(43) Pub. Date: Feb. 7, 2008

(54) Method for detecting position of input devices on a screen using infrared light emission

(76) Inventors: Denny Jaeger, Oakland, CA (US); Andrew Lohbihler, Waterloo (CA)

Correspondence Address: ZIMMERMAN & CRONEN, LLP, 1330 BROADWAY, SUITE 710, OAKLAND, CA, 94612-2506, US

(21) Appl. No.: 11/890,562

(22) Filed: Aug. 6, 2007

Related U.S. Application Data
(60) Provisional application No. 60/836,350, filed on Aug. 7, 2006.

(51) Int. Cl. G06F 3/041

(52) U.S. Cl. 178/19.01; 178/18.01

(57) ABSTRACT

A system for using IR light emitted from a wireless input device for the purpose of locating and tracking the device on a transparent sensor pad associated with an electronic display screen. The sensor pad incorporates embedded photo-sensors at the edges of the pad for detecting, identifying, and locating the input device. The input device may be powered by EM field, or light emitted by the display screen.

### CROSS-REFERENCE TO RELATED APPLICATIONS

This application claims the benefit of U.S. Provisional Application Ser. No. 60/836,350, filed Aug. 7, 2006.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to input devices that operate in conjunction with changeable electronic displays, such as computer monitors, television monitors, electronic devices such as vending machines, video recorders, voting machines, and the like.

2. Description of Related Art

In general, electronic displays may be provided with a touch-sensing device that overlays the display to accept user inputs that correspond to images portrayed by the display. The touch sensing devices may operate on principles of resistance changes, or capacitive sensing, or, more recently, optical sensing of implements or user's fingers touching the screen. The patents noted above describe touch input devices that are designed to interact with any of these forms of touch sensing arrangements to enter user inputs that change an electronic value, perform a switch function, move a displayed object or item, and the like. Applicants have designed devices for this purpose that are described in the following U.S. Pat. Nos. 7,113,175; 7,084,860; 6,700,567; 6,670,952; 6,670,952; 6,642,919; 6,642,919; 6,441,806; 6,326,956; 5,982,355; 5,977,955; 5,936,613; 5,841,428; 5,805,146; 5,805,145; 5,786,811; 5,777,603; 5,774,115; 5,712,661; 5,694,155; 5,572,239.

### BRIEF SUMMARY OF THE INVENTION

The present invention generally comprises a system for using IR light emitted from a wireless device for the purpose of locating and tracking the device on a sensor pad or screen. Generally a light emitter will illuminate the surface termed a “sensor pad” that incorporates embedded photo-sensors at the side edges of the pad, while also allowing light to be emitted through a transparent surface from underneath the sensor pad. Normally such a sensor-pad is transparent because there is a display screen (e.g., LED, LCD, OLEP, CRT) under the surface for the purpose of representing the device location with a visual icon (i.e. cursor or object) that serves a useful purpose related to the positioning. For example, a knob device will generate an arc when turned and the position of its IR emitter will be detected and hence represent a circular knob icon allowing the control of a parameter (i.e. sound volume, color intensity, etc.). Also, for example, a fader device will generate linear movement of the IR emitter that is detected to control a parameter represented by a fader icon. Other possibilities are for a “pen” stylus device that can be moved freely over the sensor pad surface to draw anything (i.e. a line, curve, object, etc.) that can be represented by many different objects.

Another embodiment of this invention provides a sensor pad coated with ITO (Indium-Tin-Oxide) or TO (Tin-Oxide) that is a metal conductor or semiconductor for the purpose of acting as a capacitive sensing apparatus used in conjunction with the IR light-sensing pad. The ITO coating may be on the top or bottom surface of the sensor pad or anywhere in between. Realistically, an ITO coating on the top surface with a protection coating is the preferred solution. A capacitive sensing surface can be used as a locating medium or as a touch-sensing medium in conjunction with the IR pen/device apparatus.

Using IR light (either far-IR, near-IR, or other visible light spectra) has significant benefits compared to electrical or EM radiation methods of touch contact over a surface. The most significant advantage is that there is no need for direct contact with the transparent surface. Direct contact with the surface is generally required in prior art devices to impart electrical or EM energy to be sensed by sensor contacts embedded on a sensor-pad. IR light, on the contrary, is not only invisible but also does not need direct contact with the sensor-pad surface to allow conduction of light into a transparent sensor pad. The disadvantage with this approach consequently is that light cannot be used to detect a physical touch of an emitter with the sensor pad. Using IR light will be sensitive to ambient sources of light. This light can be a specular or diffuse source depending on the light source type and angle that it is illuminating the sensor-pad surface. Examples are direct sunlight, windows, incandescent light bulbs, hot bodies, and other IR light sources. This invention also includes using CDMA or PN codes as a method of distinguishing IR devices of interest from interfering ambient IR sources discussed above.

### BRIEF DESCRIPTION OF THE DRAWING

FIG. 1A is a perspective view of one embodiment of the invention including user input devices in conjunction with an IR sensor pad; FIG. 1B is a perspective view of another embodiment including user input devices and capacitive position sensors.

FIG. 2 is a schematic elevation depicting an IR sensor pad, display screen, IR input device, and the ambient IR light environment.

FIG. 3A is a functional block diagram depicting the components of an IR tracked input device having a battery powered emitter circuit; FIG. 3B is a functional block diagram depicting the components of a capacitively activated, powered, and tracked input device, having a electromagnetic (EM), capacitively coupled, or EM standing wave signal powered emitter circuit.

FIG. 4 is a perspective view showing the placement of photo sensors on the IR sensor pad of the invention.

FIG. 5 is a functional block diagram depicting the components of the IR photo sensing circuit of the invention.

FIG. 6A is a schematic layout of the logarithmic detector of the present invention, and FIGS. 6B-6D are graphs of signals representing different calculation stages of the detector of FIG. 6A.

FIGS. 7A and 7B are schematic depictions of IR isolation for the knob and fader embodiments of the invention, respectively. FIGS. 7C and 7D are schematic depictions of capacitive embodiments of the knob and fader embodiments of the invention, respectively.

FIGS. 8A-8C are schematic depictions of knob post reflectivity of the input device of the invention.

FIGS. 9A and 9B are layouts of the four channel and eight channel processing configurations of the IR photo-sensor of the invention.

FIGS. 10A and 10B are layouts showing EM field powering of an input device using a resonating coil or a uniform conducting surface of the sensor pad.

FIGS. 11A-11C are schematic elevations of knob input devices powered by EM field, capacitive coupling, or EM standing wave.

FIG. 12A is a schematic elevation of a knob input device powered by light from the associated display screen; FIGS. 12B and 12C are functional block diagrams of circuits for the powering arrangement of FIG. 12A. FIG. 12D is a schematic elevation of a light collector embodiment that also utilizes light from the associated display screen.

FIG. 13 is a schematic elevation of a knob powering device that incorporates a touch sensitive switch.

FIG. 14 is a functional block diagram of a circuit for operating the touch sensitive switch of FIG. 13.

### DETAILED DESCRIPTION OF THE INVENTION

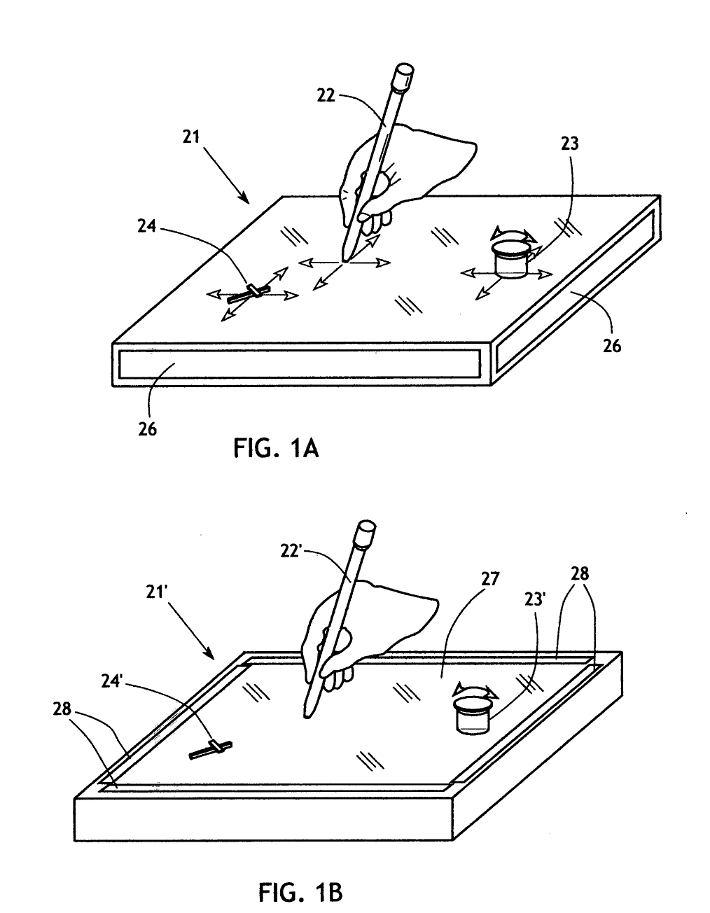

The present invention generally comprises in one embodiment a system for using IR light emitted from a wireless device for the purpose of locating and tracking the device on a sensor pad or screen. With regard to FIG. 1A, the invention provides a sensor pad 21 composed of a transparent material that easily conducts both visible and infrared (IR) light. The pad 21 may be thinner than depicted in the figure, and may have any desired shape, size, or configuration. The pad 21 is intended to be placed directly in front of an electronic display screen so that user inputs may be detected and transmitted to an electronic device that is operatively connected to the display screen, whereby the user of the invention may make inputs to the electronic device. The invention also provides at least one input device that is designed to interact with the sensor pad and direct inputs thereto. For example, the invention may provide a stylus 22, knob 23, or fader 24 to interact with the sensor pad 21. For this purpose, each of these devices is provided with an IR emitter that is directed toward the upper surface of the sensor pad 21. The sensor pad 21 is provided with photosensors 26 secured to the peripheral edges of the pad and arranged to detect IR emissions from any of the devices 22-24. For example, the knob device 23 will use the position of its IR emitter to describe a circular arc, hence representing a circular “volume control” icon allowing the control of a parameter (i.e. sound volume, color intensity, etc.). Also, for example, the fader device 24 will track the linear position of the emitter along a straight line, to control a parameter represented by a fader icon. The “pen” stylus device 22 can be moved freely over the sensor pad surface and drawing anything (i.e. a line, curve, object, etc.) that can be represented by many different objects. In all these examples the IR light emitted by the devices 22-24 is conducted through the sensor pad 21, and some of that light is scattered and received by the sensors 26, where it is detected and located, as described below.

With regard to FIG. 1B, a further embodiment of the invention provides a sensor pad 21′ that is likewise composed of a transparent material that easily conducts visible light, and may have any of the other characteristics of the previous embodiment. The pad 21′ is likewise intended to be placed directly in front of an electronic display screen so that user inputs may be detected and transmitted to a device that is operatively connected to the display screen, whereby the user of invention may make inputs to the device. The pad 21′ includes a conductive surface coating 27 (such as tin oxide or indium tin oxide). A plurality of linear capacitive sensors 28 are secured to the upper surface of the sensor pad over the conductive surface, and are located directly adjacent to the peripheral edges of the screen. The invention also provides at least one input device that is designed to interact with the sensor pad and direct inputs thereto. For example, the invention may provide a stylus 22′, knob 23′, or fader 24′ to interact with the sensor pad 21′. User movement of any of these devices is detected by circuitry described below, whereby user inputs may be made.

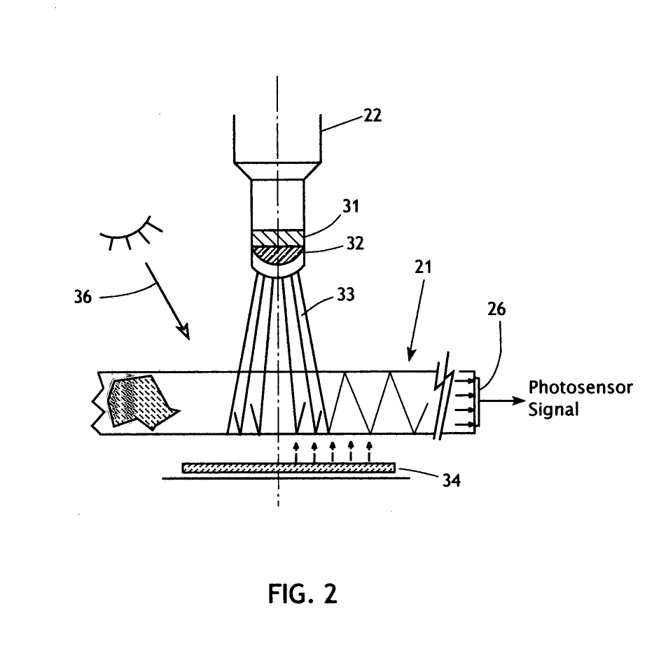

With regard to FIG. 2, the transmission of IR light of the embodiment of FIG. 1A is portrayed. As an example, the stylus 22 includes an IR emitter 31 and a lens 32 to shape the IR beam 33 and direct it toward the sensor pad 21. Some of the IR beam is reflected and scattered laterally in the pad 21 and eventually is conducted to the sensor 26, where it is converted into a photosensor signal. However, the presence of an underlying display screen 34 causes some of the IR beam to be reflected upwardly into the pad 21, where in joins the original beam signal and becomes a noise factor. Additional noise factors, represented by ray 36, include ambient light from interior lights, windows, hot objects that emit IR, and the like. Thus the sensor 26 may receive a composite signal, of which only a small portion is the beam 33. In addition, an ambient source of light can cause “shadowing” interference because a user's stationary or moving hand will block the ambient light momentarily and cause transient “signals” to be sensed by the sensor pad. Thus the actual motion of the hand manipulating the input device will be sensed and interfere with the positioning of the device. Also IR light that is not completely absorbed by the sensor pad will become “stray” light that can illuminate objects outside of the sensor pad and reflect off from these objects and become reabsorbed into the sensor pad. Generally objects placed close to the emitter will reflect the most light. Human fingers close to the sensor pad or changing orientation angles of the IR emitting device can cause such interference effects that also affect positioning. Embodiments of this patent will show how these effects can be eliminated.

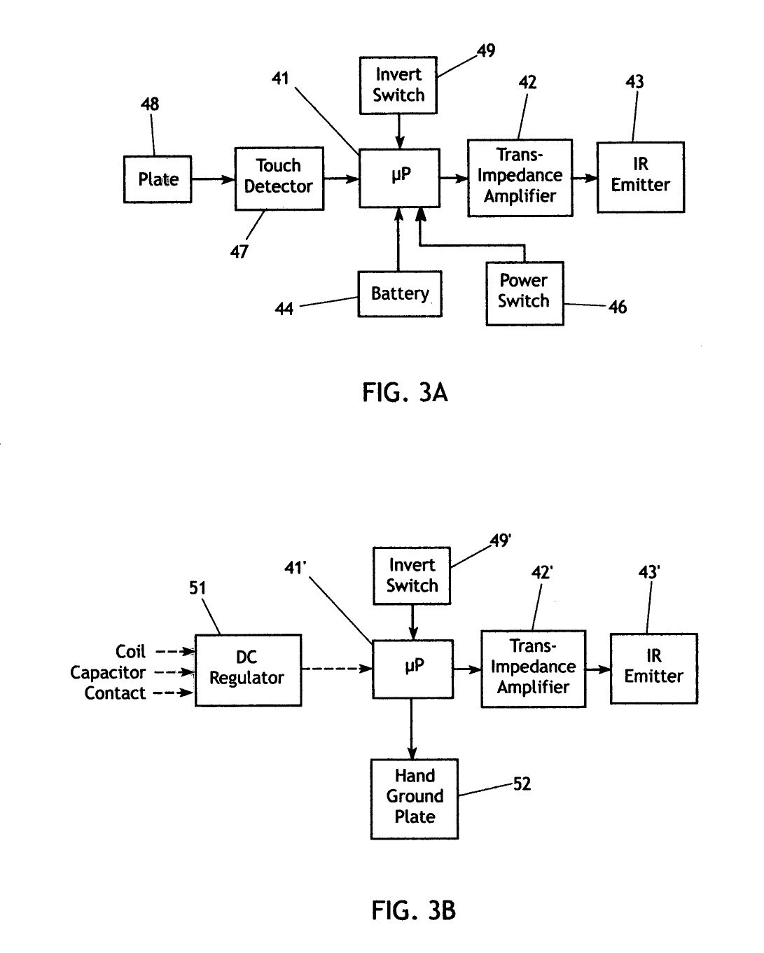

With regard to FIG. 3A, each input device for the IR embodiment of FIGS. 1A and 2 includes a microprocessor 41 connected to a high current trans-impedance amplifier 42 that drives the IR emitter 43. The microprocessor is powered by battery 44 and switched off and on by power switch 46. In addition, the microprocessor is also controlled by external input pins that allow the device to switch on using hand touch detector 47 connected to plate 48 on the exterior of the IR input device. The IR emitter is generally pulsed by the microprocessor with a spread-spectrum or Pseudo-Noise (PN) code for the purpose of allowing the device to be distinguished from ambient light and other devices. A PN code allows the device signal to be detected and “de-spread” allowing the device to be detected over noise and interference and ambient light sources. Also, the position of the device to be calculated with a processing gain that increases the positioning resolution, dependent on the length of the code and degree of signal over-sampling. In addition, the position and tracking of multiple devices can be calculated using different codes and de-spreading with digital processing techniques that search for and isolate the independent PN codes. Processing methods exist to detect and position the emitters of multiple devices.

A click button switch 49 inverts the PN code so the switch information can be extracted in the digital processing while still allowing an XY position to be calculated. Typically the PN code sequence is run using a compact Linear-Feedback-Shift-Register (LFSR) algorithm, or as a sequence of stored PN bits in an SPROM or ROM which would be typically built into the uP. Such an emitter can be powered by a battery (i.e. a long life lithium battery) with a relatively low DC voltage, as shown in FIG. 3A.

Alternatively, the emitter circuit can be powered using a DC voltage induced from a rectified EM field that is wirelessly transmitted from the sensor-pad. As shown in FIG. 3B, wherein components common to the embodiment of FIG. 3A are given the same reference numeral with a prime (′) designation, the microprocessor 41′ is connected to a DC regulator 51 that is in turn fed by a coil or capacitor contact, as described below. The microprocessor 41′ is not connected to a battery, but rather relies on current induced through capacitive coupling. Other embodiments using rectified EM fields described below also employ the circuit layout of FIG. 3B. A hand ground plate 52 is connected to the microprocessor 41′ to complete the induced current circuit.

It is important that an emitting device (i.e. knob, fader, stylus, etc.) efficiently transfer the pulsed IR into the sensor-pad for the purpose of avoiding the re-absorption of pulsed IR from reflecting objects. Reflecting objects will cause a device positioning error (see FIG. 2) because a reflecting object acts as an additional IR source with the same PN pulsed sequence. The degree of reflection interference varies with the distance between the reflecting objects and emitter (i.e. closer objects reflect more light and have more error). There are digital methods of removing such effects but the easiest solution is to remove the incidence of IR reflection from the sensor-pad.

The efficiency of the sensor pad in conducting the IR signal to the detectors 26 is improved by the ability of the IR conducting medium of the sensor pad to perform Total Internal Reflection (TIR). TIR is hard to achieve in this case because part of the light cone has an insufficient angle of incidence to be scattered and internally reflected. Attaining more internal reflection can be improved by using impurities of an IR light reflecting or refracting substance. Such substances are known to refract IR at a high refractive index greater than 2. For example, titanium dioxide as a coating or as a mixed impurity can internally refract IR light more efficiently than using a clear sensor-pad material. Another method of improving the internal reflection of IR light is to use a wide angle IR emitter. A wider light-cone will allow more IR light to refract through the sensor-pad allowing more light to reach the photo-sensors. This has been shown to cause difficulty because wider emitters can be easily interfered upon by external objects that can come close to the emitter (such as fingers or the sensor pad edge).

Generally the best substance for reflecting IR light internally is Plexiglas or acrylic because they can be made with less purity than normal glass. Tinted computer screen Plexiglas has been successfully used to make prototype sensor pads that are still very transparent to display screens. Such sensor Plexiglas is also very inexpensive and is very durable for many applications. Various manufacturers of Plexiglas material can make the material doped with impurities or substances that improve the IR internal reflecting capability.

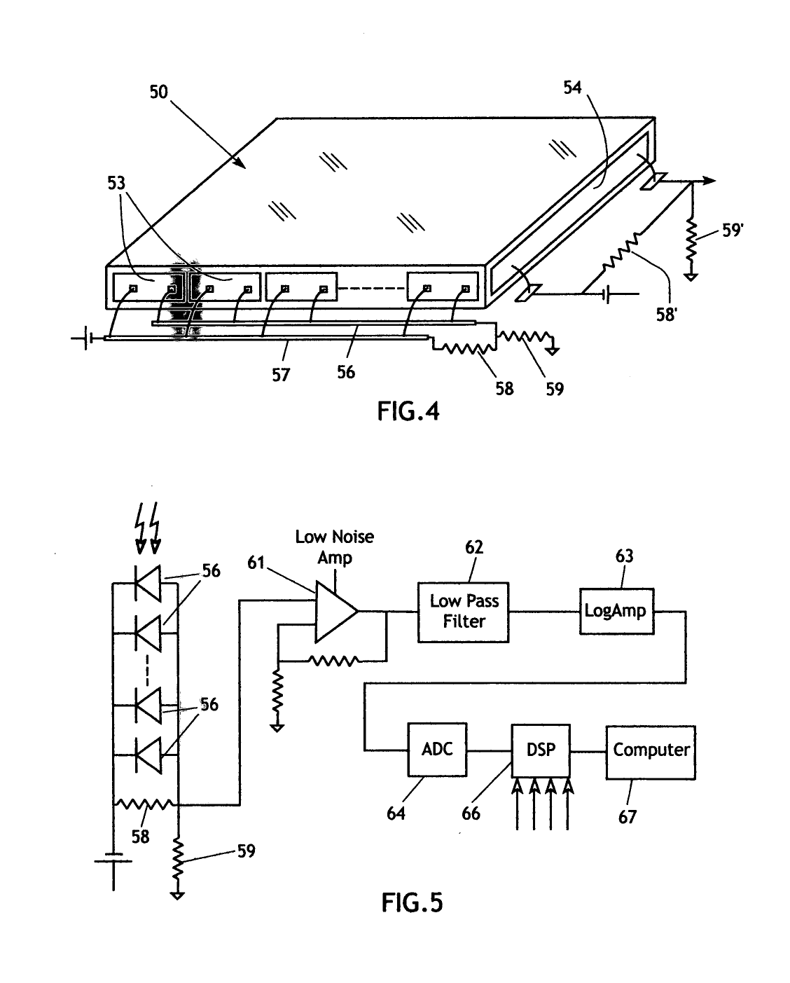

With regard to FIG. 4, a preferred form or shape of the sensor-pad is a square or rectangular piece of Plexiglas such that the edges are straight and perpendicular to the sensor face. As an example, a plurality of photosensors 53 are flush mounted to one edge, and a single photosensor 54 is mounted to an adjacent edge of the sensor pad. Other arrangements for mounting the sensors are possible, such as an angular mounting, or a flat mounting to the sensor-pad face that would require that the IR be reflected is such a way that the sensor can pick up the IR signal transmitted through the sensor-pad. The sensors flush mounted to the side of the pad is the simplest and least expensive solution. Sensors can be added as a single unit to completely cover the edge of the sensor-pad, or be added as multiple units to overall cover the sensor-pad edge. The plurality of sensors 53 are connected in parallel between bus connectors 56 and 57, with a resistor 58 connected therebetween to maintain a voltage bias between them, and a resistor 59 connected from the resistor 58 to ground maintains the detectors above ground. Likewise, the single photosensor 54 has leads connected across resistor 58′ and is held above ground by resistor 59′.

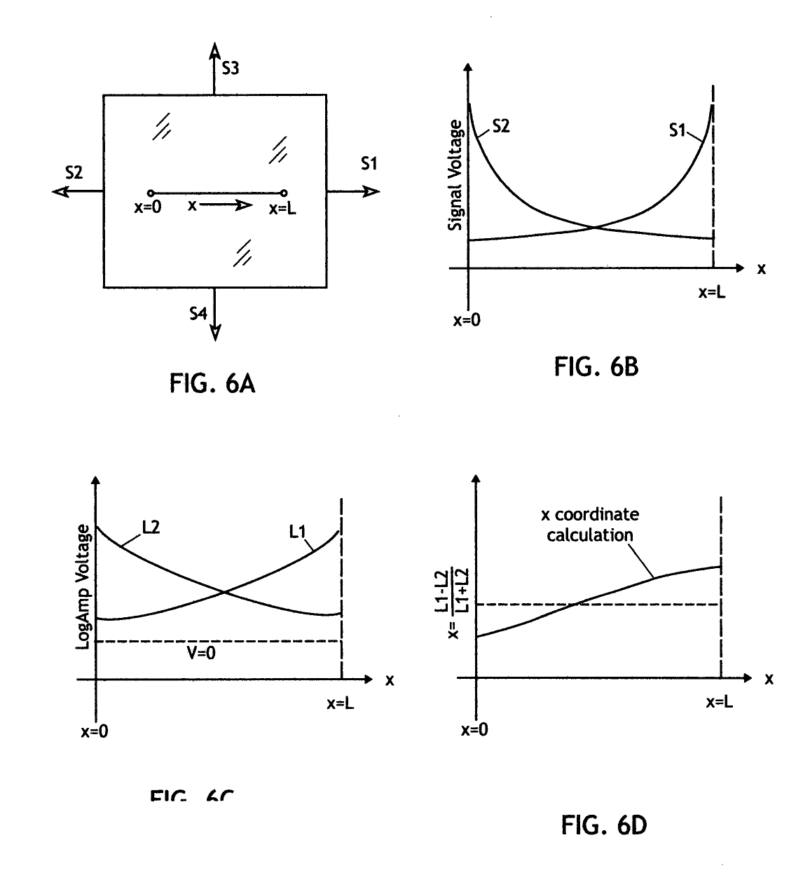

With regard to FIG. 5, the IR signal detection circuit for the photosensors 56 and 56′ includes a low noise (high impedance) amplifier 61 that feeds a signal through a low pass filter 62 to a high impedance logarithmic amplifier (LogAmp) 63. The low noise/high impedance amplifier 61 is necessary to convert the signal to a current trans-impedance signal that is detectable by the LogAmp 63. The output of LogAmp 63 is fed to ADC 64, and the digital signal therefrom is fed to DSP 66 and thence to computer 67. The computer may employ the position data and calculate changes in position data to control the display screen that is associated with the sensor pad 50, moving onscreen objects or representations in correspondence with the changing position data, and likewise altering values, levels, connections, associations, and the like that are correlated with the onscreen objects or representations. It is important for the photo-detection circuit work at high speed to allow detection of rapidly switching signal potentials. For that purpose photo-conduction sensors are required. These detectors work with lower capacitance and will respond to rapid changes in signal voltage such as the light from a pulsing IR emitter. These devices can operate to detect signal changes at up to 1 MHz or more. This choice of technology is to distinguish from photo-voltaic devices which operate at higher capacitance and higher voltage, but cannot respond to faster signal changes.

Another significant feature of photo-detection at this stage is that analog signal filtering is required to minimize or eliminate noise effects and voltage bias. This is required to maintain a detected signal that can be immune to effects that are caused by “shadowing” (light occlusion) and interference from light reflecting objects. At the analog circuit stage it is not important to eliminate these effects but to minimize these signal artifacts so they can be digitally filtered or masked out later. Signal filtering serves to minimize the signal artifacts of noise and shadowing transients rather than remove them completely. A typical analog filter like low-pass filter 62 will remove a DC bias (as from sunlight exposure) and any signal artifact that has a signal component less than 500 Hz, such as the 120 Hz line oscillation that appears in the IR ambient light from an incandescent light bulb. Note that additional digital filtering (as by DSP 66) such as using a matched-filter will remove signal bias and artifacts of lower frequency signals that are not removed by analog filtering.

The invention features the use of a logarithmic photo-detector for the purpose of detecting a variation in the signal potential that varies with a power law. That is, when a photo-detector is illuminated and converts the light to electrical energy, the variation in voltage (or current) varies with the square (or cube) of the distance that the photo-detector is from the source of the IR light. Because of the complexity of the power of the light moving through the sensor-pad medium, the illumination power variation of the light is not exactly known, hence the power variation with distance is not exactly known to a specific integer power. Therefore generally a conservative approach is to use a LogAmp detector to convert the photo-detected signal to a linear output signal. Ideally the output signal should vary as linearly as possible, but sensor-pad edges have complex optics that make this goal difficult to obtain. At best the output signal appears linear up to a short distance from the photo-sensor.

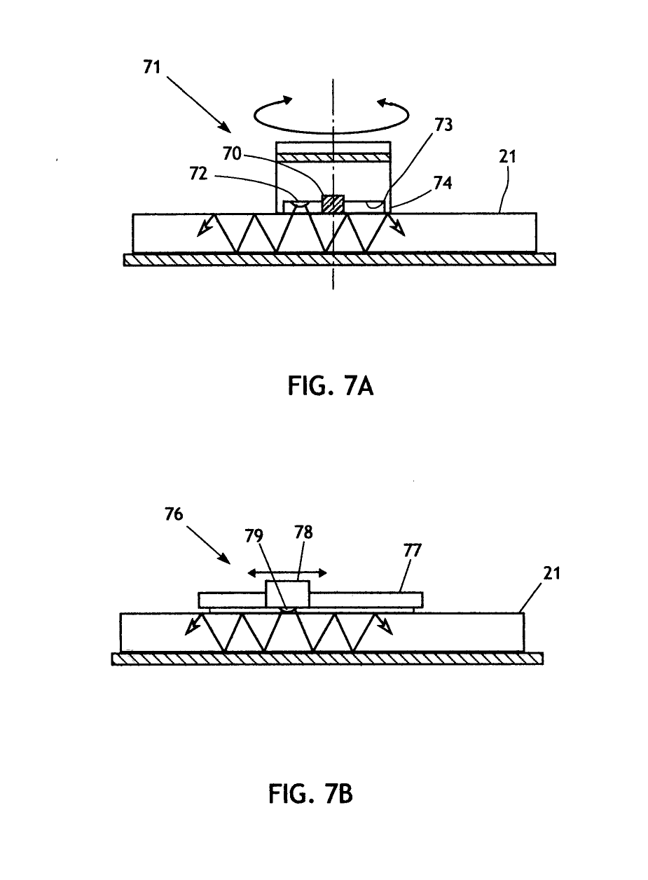

With regard to FIG. 6A, as an example an IR emitter moves on the sensor pad from position x=0 in a linear direction to x=L. The signal from sensor S1 increases logarithmically as the IR emitter approaches it, while the signal from sensor S2 decreases logarithmically as the emitter translates and recedes therefrom (see FIG. 6B). The output of the logarithmic amplifier, as shown in FIG. 6C is L1 and L2 corresponding to sensor signals S1 and S2, respectively. The L1 and L2 signals are fairly linear in the mid-range, although there is a variance therefrom at positions close to x=0 and x=L (the edge effect). Plotting (L1−L2)/(L1+L2), as shown in FIG. 6D, leads to a more linear signal output, with a reduced edge effect.

Another advantage of using a logarithmic detector circuit is that the detectors can be assigned a threshold to negatively bias ambient light and noise for the purpose of masking it out. This is accomplished by using a shunt resistor (such as resistors 58 and 58′ in FIG. 4) that will apply a bias voltage across the photo-detector(s). This will apply an electrical “noise” about the detector, thus limiting the sensitivity of the detection of signals. Any ambient effects will hence be “fuzzed-out” or squelched by the artificial noise created by a shunt resistor. The advantage of this approach is that it is simple and enables engineering emitter signals that can be significantly stronger than the largest ambient noise or signal artifacts related to ambient light. The logarithmic detector will then be negatively biased (i.e. circuit adjusted to register a negative signal voltage output) to completely squelch the noise created by the shunt resistance. The simplicity of this solution is that it leads to adjusting shunt resistances automatically to changing ambient light environments. In the absence of any code generating signals the LogAmp 63 can be automatically adjustable to squelch ambient noise. This circuit action is similar to the function of an automatic-gain circuit (AGC), suitably modified to instead remove ambient signal artifacts.

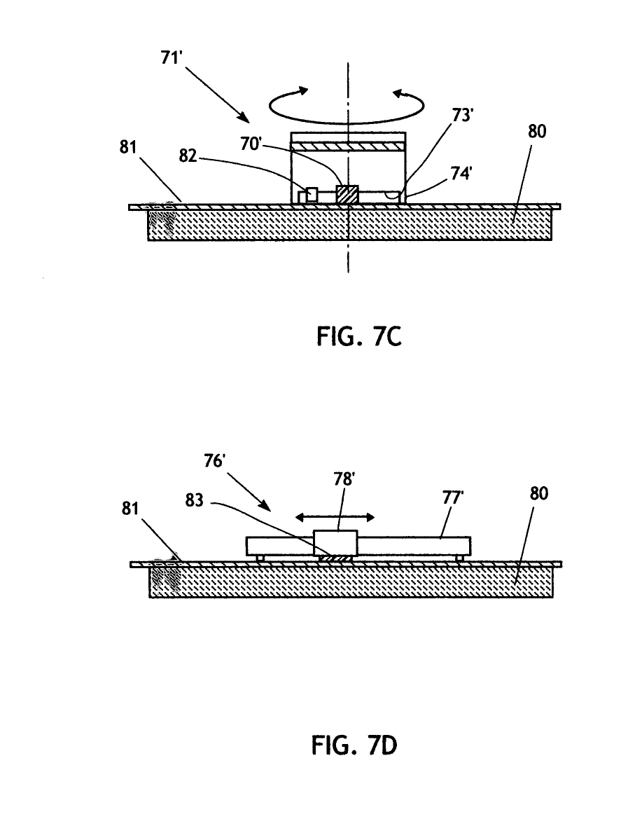

Ideally the devices emitting IR light cannot allow any interference to exist between the IR emitter and the sensor-pad medium. Therefore it is better to control the medium between IR emission and sensor-pad by isolating it from the environment. FIG. 7A illustrates one form of this IR transmission isolation for a knob device 71 rotatably mounted on post 70 secured on a sensor pad 21. The knob 71 includes an IR emitter 72 disposed off-axis so that is sweeps through an arc as the knob is turned about the post. The emitter 72 is disposed in a recess 73 formed in the bottom surface of the knob which forms an annular skirt 74 at the periphery of the knob. The skirt 74 isolates the emitter such that the IR output has no exposure to the outside environment and thus does not allow the IR from the emitter to be in contact with any interfering object.

With regard to FIG. 7B, similar isolation may be provided for a fader device 76. The fader includes a track 77 secured to a sensor pad 21, and a manually operated slider 78 secured to the track. An IR emitter 79 is disposed on the bottom surface of the slider 78 and positioned in contact with the sensor-pad medium, hence improving the efficiency of IR absorption into the sensor-pad.

Neither the knob nor fader can allow the emitter to change in orientation. Therefore it is necessary for the emitter to be rigidly mounted to the knob or fader, or any other device that operates an emitter. Slight changes in orientation can cause the emitter to generate light that is slightly biased toward the sensor that the emitter is tilted toward. Knobs and Faders can be rigidly mounted and fixed to the device body, however this cannot be said for emitters mounted on a pen/stylus. Typically an emitter that uses a wider angular spread of IR light will be less sensitive to changes in the orientation angle. However, such an emitter can be more sensitive to interference of objects or fingers in the local area.

With regard to FIG. 7C, a knob 71′ designed for a capacitive sensor pad 21′ is rotatably mounted on a post 70′ secured to a conductive coating 81 applied to a transparent substrate such as a glass panel 80. The knob includes a capacitive transducer 82 disposed off-axis so that is sweeps through an arc as the knob is turned about the post. The transducer 82 is disposed in a recess 73 formed in the bottom surface of the knob which forms an annular skirt 74 at the periphery of the knob. The skirt 74 isolates the transducer 82 such that the capacitive output has no exposure to the outside environment and thus minimizes interference from any nearby object.

With regard to FIG. 7D, similar capacitive isolation may be provided for a fader device 76′. The fader includes a track 77′ secured to a conductive coating 81 applied to a transparent substrate such as a glass panel 80, and a manually operated slider 78 secured to the track 77′. A capacitive transducer 83 is disposed on the bottom surface of the slider 78′ and positioned in contact with the conductive surface 81 such that the capacitive output has minimal exposure to the outside environment and thus minimizes interference from any nearby object.

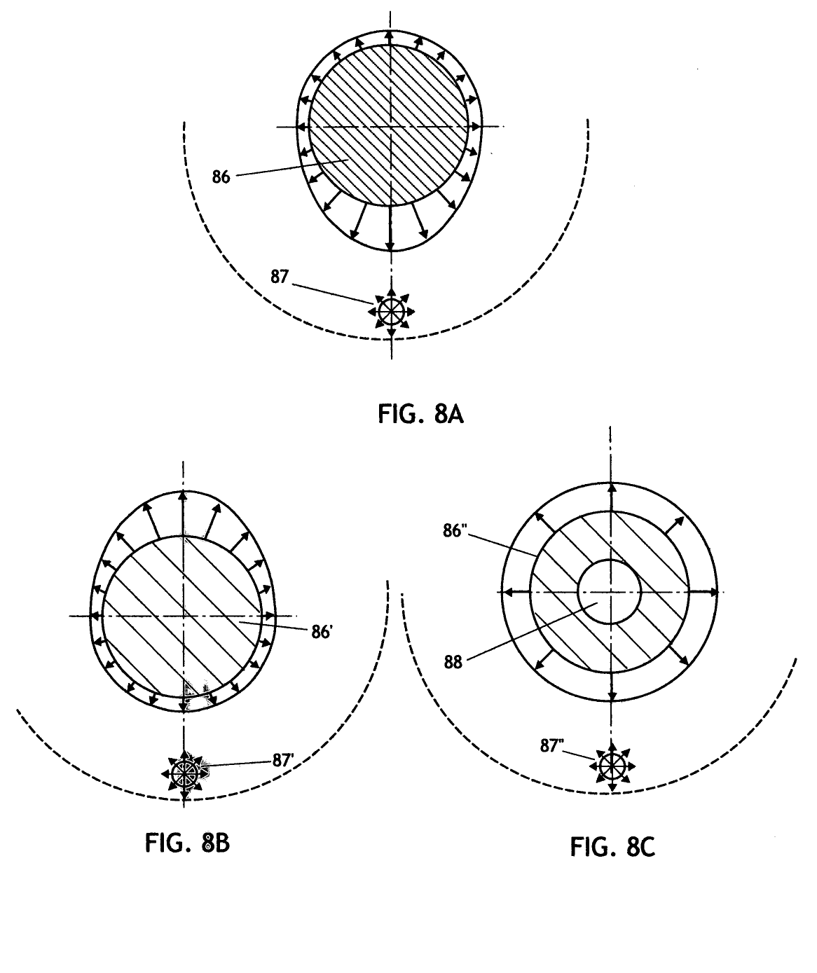

It is also important for the knob or fader to use a support post or sliding lens that does not interfere with the optical absorption of IR into the sensor pad. A knob will typically use a post for rotational support; however such a post may reflect IR or absorb IR to interfere with the linearity of the IR sensed by the sensor-pad detectors at the edge. For example, with reference to FIG. 8A, a non-transparent post 86 of a knob device interacts with associated IR emitter 87 by tending to reflect IR light outward from the post and distorting the positioning circle into an ellipsoid. This effect leads to errors in position detection of the knob angular attitude. Conversely, as shown in FIG. 8B, a transparent post 86′ transmits and refracts the incident IR light, tending to collimate the IR light and concentrate it through the post to produce a complex but compact but non-circular shape. This effect also leads to distortion of the positioning circle, creating errors in position detection of the knob angular position. One solution to the problems portrayed in FIGS. 8A and 8B is shown in FIG. 8C. A transparent knob post 86″ with a bore 88 extending axially therethrough tends to scatter incoming light in all directions and not allow light collimation or any form of “lensing” phenomenon to occur. As a result, the positioning circle about the knob device is not distorted, and knob position detection errors are minimized.

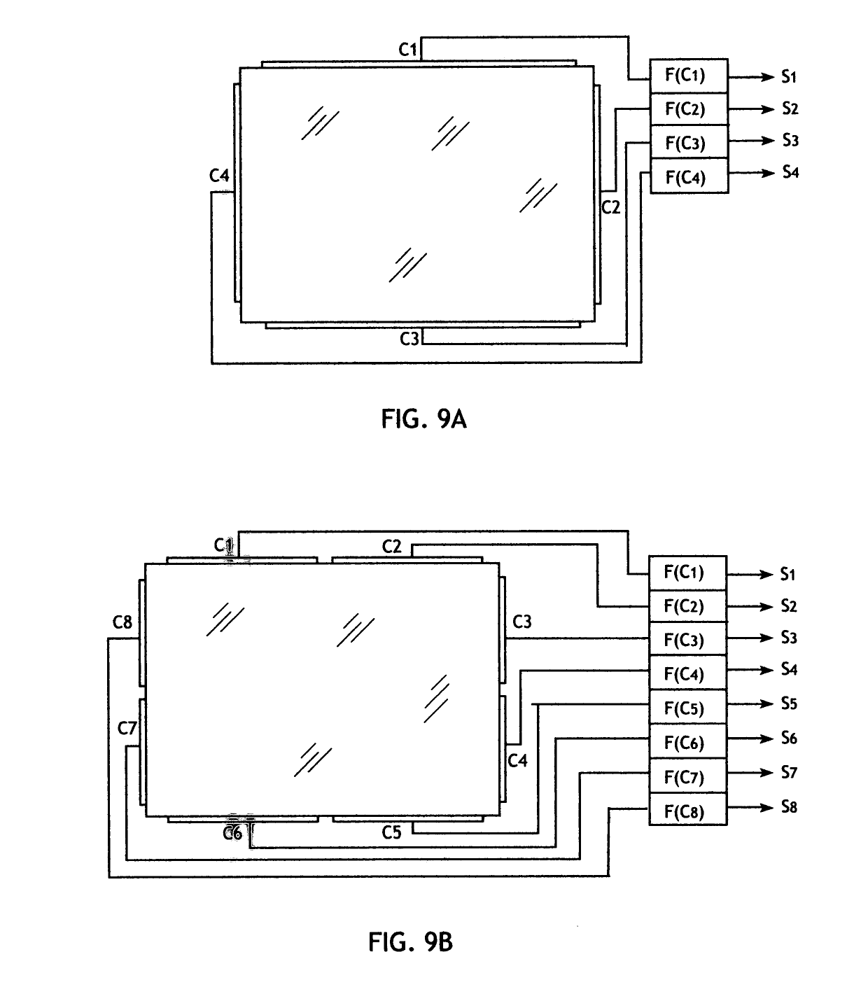

The position detection of an IR emitting device depends on the sensor-pad receiving enough IR light to all sensors arranged on the outer edges of the sensor pad. In this case the 4-channel configuration is used as shown in FIG. 9A. Before device position calculations are undertaken, the presence of a device must be detected. The method of device detection is to determine that a threshold has been exceeded for ALL of the signals received simultaneously and processed in the channels of each sensor group. A “sensor-group” is all the sensor signals cascaded together and operating in parallel. In this example we will use the function F(*) as the matched filter that does the de-spreading of the CDMA signal. Hence the device is detected if the following is true:

S1=F(C1), S2=F(C2), S3=F(C3), S4=F(C4)

where C1, C2, C3, C4 are channel signals sampled for a 4-channel digital processor, and
S1>T, and S2>T, and S3>T, and S4>T, where T is the present threshold. Hence the position calculations are normalized and calculated as:

X=(S2−S4)/(S2+S4)

Y=(S1−S3)/(S1+S3)

Based on the choice of the method for mounting the sensors to the edge, the above calculations are linear to a high degree, but mainly inside the middle of the sensor-pad area. This linearity is maintained only until the emitter is close to the edge of the sensor-pad. At that point the linearity gradually reduces because the signal closest to the emitter becomes much larger than the signal measured at the opposite edge. One method of keeping linearity with this optical “edge-effect” is to avoid allowing an emitter to get close to this edge. This can be accomplished by simply hiding a portion of the sensor-pad beneath a bezel that prevents the IR emitter to contact the non-linearity edge portion of the sensor pad. This arrangement does not result in the most compact sensor pad.

However, if the edge cannot be avoided then a better approach is to not allow the signal from the closest edge to enter into the coordinate calculation. In the 4-channel configuration the coordinate calculation cannot avoid using the signal from the closest edge because only the closest edge and opposite edge signals are used in the calculation. Thus a non-linearity will occur in the coordinate calculation that cannot be avoided.

It is important that the calculations for X and Y use normalization because there are several factors that affect the amplitude level of output signals. Normalization keeps a consistent position calculation hence reduces errors caused by changes of amplitude in the channel signals. For example, the brightness of the emitter can change with time caused by an emitter wearing out or becoming less responsive. The voltage or current level to the emitter may change as the battery wears down. There can be an increase in noise in the analog circuit caused by EMI, hence reducing the SNR of the channel signals. Also, an increase in ambient light bias or noise can cause a reduction in voltage levels to the channel signals. Normalization in the coordinate calculation actually removes these effects that otherwise can cause positioning errors.

Another method of solving the “edge-effect” is to use an 8-channel configuration design for the photo-sensors. When 8 channels are used in a sensor-pad configuration (shown in FIG. 9B), each edge is split into two sensors rather than a single sensor per edge, and an improvement in the XY calculation can be realized. The calculations for such a configuration are:

XA=((S7+S8)−(S3+S4))/(S3+S4+S7+S8)

XB=((S1+S6)−(S2+S5))/(S1+S2+S5+S6)

YA=((S1+S2)−(S5+S6))/(S1+S2+S5+S6)

YB=((S3+S8)−(S4+S7))/(S3+S4+S7+S8)

where the A and B designations indicate the two sensors at each edge of the sensor pad. Using multiple XA and XB calculations serves the purpose of choosing which calculation is not affected by non-linearity as the emitter device gets close to the edge. For example, if the emitter is close to the edge where S1 is measured, then a digital processor will choose the calculations XA and YB for the output of the emitter because there will be no edge-effect non-linearity related to the emitter being close to the sensor that produces the signal amplitude S1.

In each case when CDMA signals are received and de-spread, there is an improvement in the resolution of the positioning by a measure that depends on the length of the CDMA or PN code. For example, assume that an analog signal of sensor C1 is measured using a 12-bit analog-to-digital converter (ADC), of a 127-chip PN code. Then the de-spread signal S1 (remember that S1=F(C1)) will yield an output that represents a 19-bit signal resolution. If signal over-sampling is used then that resolution will increase by the degree of over-sampling. For example, if a 5-to-1 over-sampling ratio is used then the output for S1 will hence represent a 24-bit signal resolution. There is little practical benefit to this increase in signal resolution because generally standard screen drivers use a 12-bit screen position resolution so the top 12-bits will need to be sampled.

Note that a standard emitter uP and digital processor use independent digital clocking signals. Ideally these clocks should be matched as closely as possible. This is not usually possible and can add to a clocking error “noise” that contributes to a positioning error. Digital signal over-sampling tends to reduce the error related to this lack of clocking synchronization. Over-sampling by a factor of 5 to 10 is usually sufficient but digital methods of “correlation-peak” tracking can further reduce the positioning error associated with the clock synchronization error.

Linearity is achieved with the use of a full edge of photodetectors. The linearity is not perfect but will be linear for almost the full length of the edge even for larger sizes of sensing-pads. It is the cascaded parallel arrangement of the photosensors that makes sensing linear. However, as the light pen/device approaches the end of the edge the photosensitivity of the edge is reduced, hence a minor nonlinear effect will occur. These nonlinearity effects will be most apparent near the corners of the sensing-pad. The best way to compensate for this edge effect is to use a digital “least-squares” calibration method to correct for the nonlinearity mathematically, and this is described in the next section.

The following is a useful method of calibrating the sensor-pad based on the channel measurements without coordinate calculations. This method requires a theoretical “least-squares” fit of phase measurements to the coordinate calculations. This was determined by expanding the coordinate calculations using “2^{nd} order” terms. Hence we will assume that a 2^{nd} order fit is a good approximation to compensate for non-linearity remaining in the XY calculations.

Using the four channel calculations denoted as:

A=S₁, B=S₂, C=S₃, D=S₄

### Define G as the measurement vector with the following “2^{nd} order” structure:

G=[1, A, B, C, D, A², AB, AC, AD, B², BC, BD, C², CD, D²] (1)

Then the following equations are defined as the coordinate calculations:

Xₐ=GCₓ, Yₙ=GC_{y} (2)

where the calibration vectors Cₓ, C_{y} are initially unknown and each vector contains 15 calibration coefficients. During a calibration procedure, the exact emitter positions are known for (Xₙ, Yₙ) that must equal or exceed 15 measurement points to uniquely solve for the calibration coefficients. Once these exact positions are obtained along with the measured G vector for each point, then the calibration coefficient vectors can be determined by “least-squares” using the following matrix formulae:

Cₓ=(G^{T}G)⁻¹G^{T}Xₙ, C_{y}=(G^{T}G)⁻¹G^{T}Yₙ (3)

Once calculated, by calibration software in a host computer, the calibration vectors Cₓ, C_{y} are stored in non-volatile memory associated with the processor. They are then available to compute any new (X,Y) set of tracking coordinates, using:

X=GCₓ, Y=GC_{y} (4)

Where G is a vector calculated using equation (1) and signals (S₁, S₂, S₃, S₄), and the coefficient vectors Cₓ, C_{y} are optimally estimated using equations (3), and fixed in value.

Note that the design of this calibration scheme need not use the full size of the G vector (equation (1)) with 15 states but may use a subset depending on the degree of non-linearity required for this application. It is believed that only a 5 state calibration scheme is really only required for the IR emitter application for XY position calculations and non-linearity calibration. This scheme can also be used for an 8-channel design as well as for the 4-channel design shown in FIGS. 9A and 9B. In terms of hardware implementation of a calibration scheme as discussed, the use of a “Farrow filter” is recommended because it allows the calibration vector to be easily calculated for a high speed digital processing application.

A further embodiment of the invention includes simultaneous and/or sequential operation of multiple devices on the sensor pad. This is accomplished using a digital method for identifying and resolving the position of each device. This is achieved by employing a matched filter designed in algorithmic code to embed inside a FPGA or ASIC. Matched filters are commonly used in CDMA systems because long PN codes can be separately and simultaneously matched inside a processor using only a single input signal that contains a composite of signals from multiple devices. A single channel signal from a sensor is digitized and sampled, the speed of the digital sample determines the sliding rate of the input signal relative to the matched code. The matched filter hence de-mixes the independent device signals and determines the device codes, and their amplitudes from the composite signal (for XY position detection purposes). Depending on the number of matching codes required for the application system, the digital algorithm must implement several parallel matching channel structures to independently detect and determine the amplitude of the matched device signal. Other designs may use interleaved matching codes to detect multiple devices, and determine their amplitudes.

As a practical implementation of device detection and XY position detection, the design of a parallel digital matched filter would require four MF channels for each device code to get device detection and XY position. If an interleaved code structure is implemented instead then the MF design would only require four channels for any number codes but require an increased clock speed of the processor in proportion to the number of codes. For example, one code needs one times the filter clock speed, 2 codes need two times the clock speed, and N codes require N times the clock speed, etc. Details of matched filters and their implementation for identification and position detection are found in published application 2004/0056849.

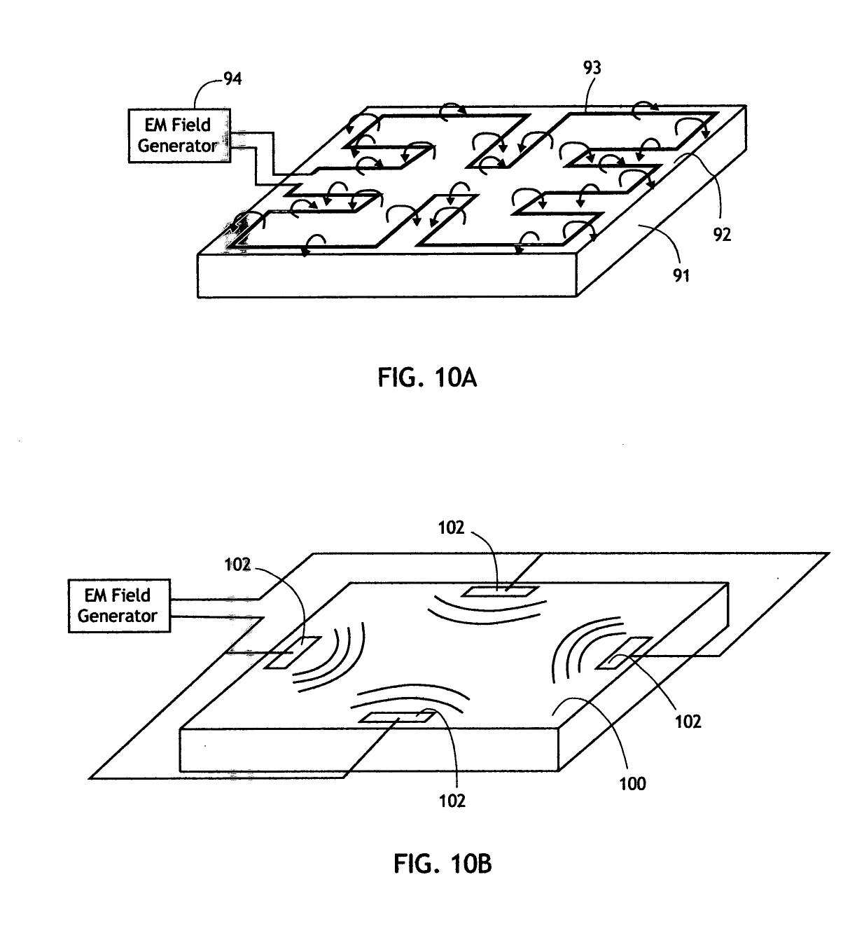

With regard to FIG. 10A, the invention also provides for remote wireless powering of the IR emitter devices. Wireless power transmission is feasible because the IR emitter devices operate on low power to begin with, and can be powered with an EM coil with an EM source generated in the vicinity. Ideally the emitter device is small enough to allow the emitter to be operated with a miniature coil and a miniature power conversion circuit that will regulate the power source to convert AC to the DC power required to operate the emitter circuit. A sensor pad 91 includes a transparent glass surface 92. A transparent, conductive trace 93 is applied on the upper surface of the sensor pad and connected to an electromagnetic field generator 94. The signal from EM generator 94 is radiated by the conductive trace to produce a local EM field at the surface of the sensor pad.

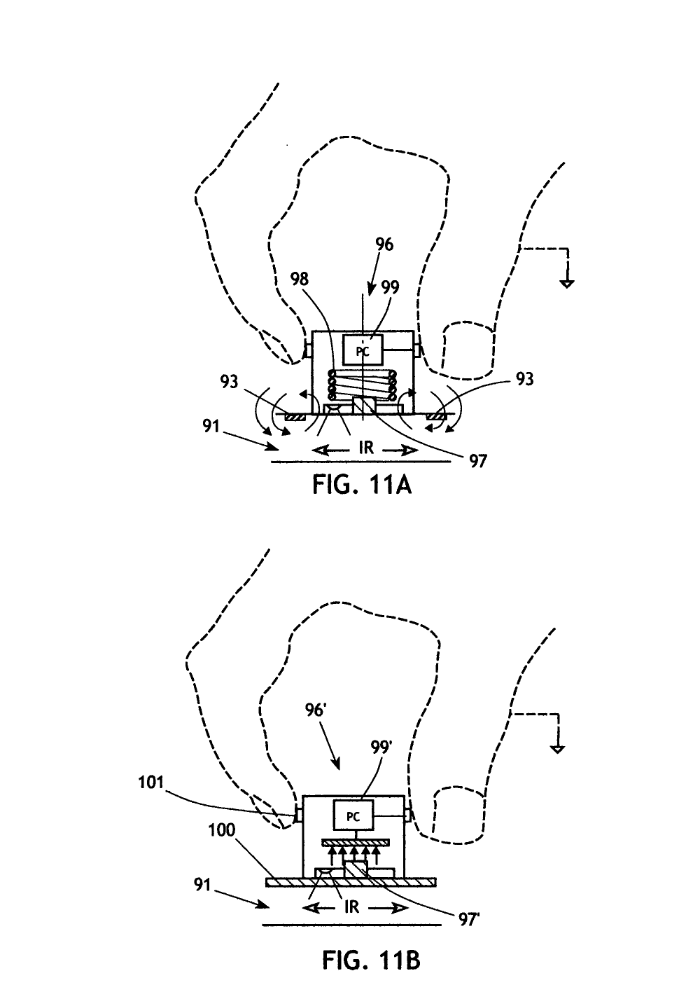

With regard to FIG. 11A, a knob device 96 mounted on post 97 secured to the surface 92 is provided with a powering coil 98. The coil 98 is configured to be resonant at the frequency of EM generator 94, and the output of coil 98 is fed to power circuit 99, where it is rectified, regulated, and fed to the IR emitter through a hand operated switch 101. Alternatively, a similarly transparent but uniform conductive coating 100 (FIG. 10B) can conduct an EM field as a standing wave to either conduct or radiate EM power to an emitter circuit that is placed down onto the sensor-pad, using the same EM field generator 94 and contact pads 102 at the edges of the conductive coating 100. The advantage of the first approach is that a radiating EM field is genuinely wireless and requires that the emitter powering circuit use autonomous coils to induct the power without any contact. The disadvantage is that the technology is complex and more costly, and requires more power to radiate through the irregular pattern of ITO trace 93 to generate a sufficient EM field distribution. The latter approach has the advantage of simplicity of design and lower cost, but would require a direct or capacitive contact to allow enough power to be conducted to the emitter powering circuit.

In either case, an Indium-Tin-Oxide (ITO) sensor-pad surface could be used with either a uniform coating or a pattern imprinted on it that resembles a fractal. The purpose is to achieve a design of a grid that allows the glass to be transparent but also distributes the EM power to any device on the surface. It is important only to get a grid pattern that distributes an optimal amount of EM energy to the device coil, to get a 3-volt charge and a minimum of 10 mw into the circuit to power the IR emitter.

With regard to FIG. 11B, a knob device 96′ adapted to be powered by the standing wave of FIG. 10B includes a capacitive pickup plate 103 that feeds an induced voltage signal to the power circuit 99′. With regard to FIG. 11C, a knob device 96″ provides a contact pad 104 that directly contacts the ITO standing wave conductor 100, thus inducing a power signal directly and feeding the power circuit 99″. In all cases the powering circuit resembles a power supply circuit using diodes to rectify the AC and hence use a power control chip to control the DC output to exactly 3 volts. Generally, a Zener diode (or other voltage regulator) is used to ensure that higher voltages do not enter the uP and emitter circuits. In either approach the powering switch function occurs by using a human hand ground plate contact. In the embodiment of FIG. 11B a hand touch exposes the circuit to a ground reference that causes an electrical flow strong enough to operate the circuit. It is possible for an EM powered circuit to operate without human grounding, but human grounding usually adds extra ground potential to make the circuit operate with higher power.

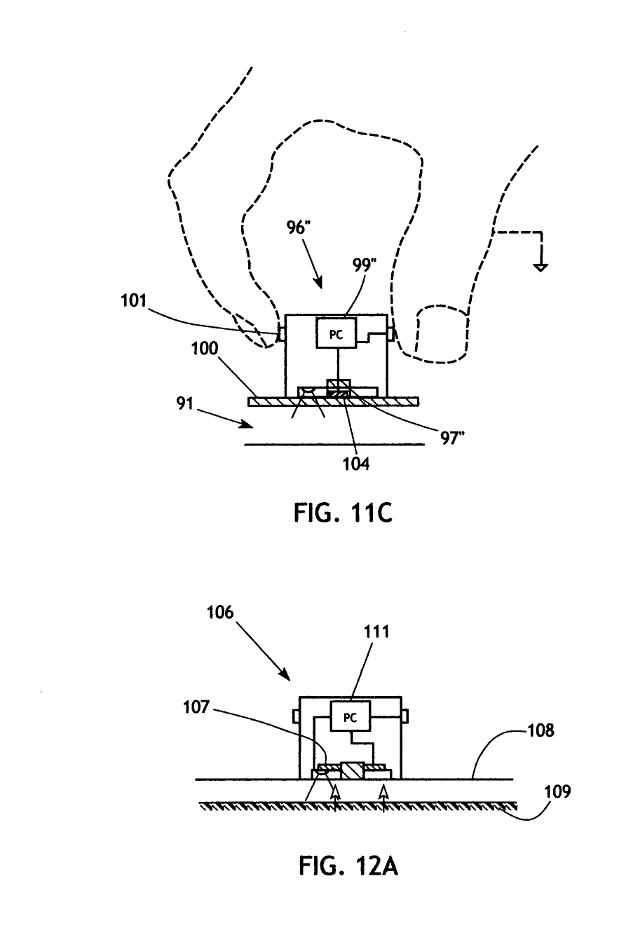

A further embodiment of the invention makes use of the light from the display screen associated with the sensor pad to provide sufficient power to operate the IR emitter of an input device on the sensor pad. With regard to FIG. 12A, a knob 106 mounted on a sensor pad 108 receives light emanating from display screen 109 to which the sensor pad is secured. Knob 106 includes photovoltaic cell 107 that receives some of the display light, converts it to a power signal, and feeds the power signal to power circuit 111. With regard to FIG. 12B, the power circuit 111 may include a DC regulator 108 that supplies power to a microprocessor 109 and trans-impedance amplifier 111. The microprocessor generates the appropriately coded signal and feeds it to the trans-impedance amplifier (TIA) 111, which in turn drives the IR emitter 112. This circuit requires that the photovoltaic generate a sufficient voltage to continuously operate the uP and emitter circuit. Therefore a sufficient light power and photo-sensing surface area is required to generate the required voltage. A circuit operating this way needs continuous and strong display light and a relatively low IR emitter power.

Alternatively, as shown in FIG. 12C, this circuit may be aided by a battery 113 to generate the required extra voltage to operate a higher power emitter. This circuit makes use of continuous power generated from the photovoltaic cell 107 but also charges the battery 113 to store extra power when the emitter is not operating. This configuration is limited by the brightness of the display and photovoltaic conversion power to charge the battery. If the charge time exceeds the drain time then this method can sustain the power requirements of the knob device.

A further alternative, shown in FIG. 12D, provides a knob device 116 that is provided with a light collector 117 directed toward the display screen 109 to gather visible light therefrom. The collected screen light is fed to a crystal 118 that is comprised of a material capable of converting the visible screen light into longer wavelength IR light. Crystal 118 incorporates a polarization filter that is activated and inactivated in response to the PN code generated in shutter control (SC) 119, whereby the output of crystal 118 is modulated IR light carrying the PN code of the device 116. The crystal output is conducted through fiberoptic cable 121 to the sensor pad 108 for detection and position calculation as described above. There are various crystals that allow for this visible-to-IR light conversion to take place; however, the efficiency of these crystals for conversion to the IR spectrum will vary. Power is required to operate a PN code polarization filter, but it draws significantly less power than an IR emitter.

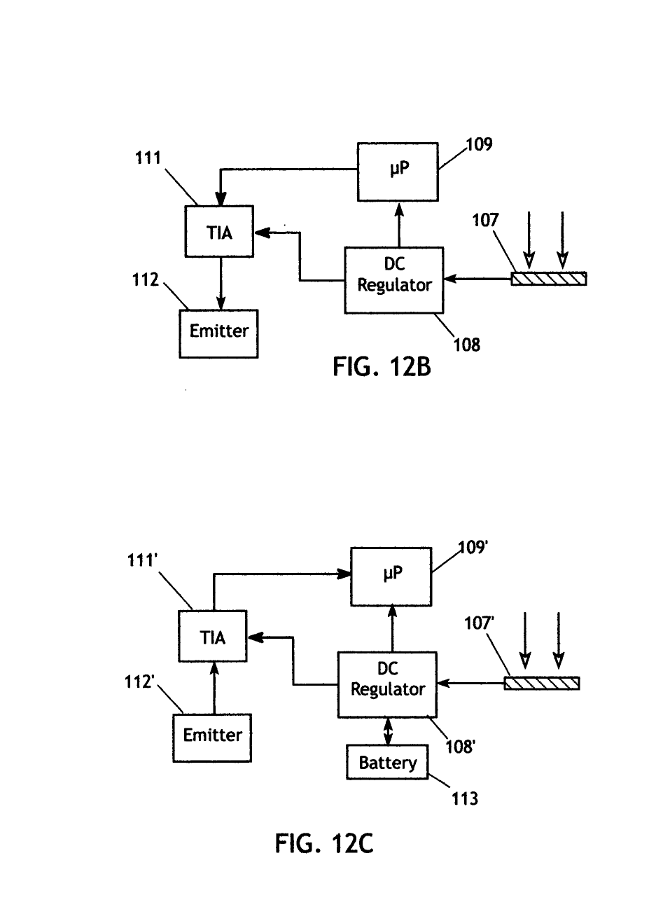

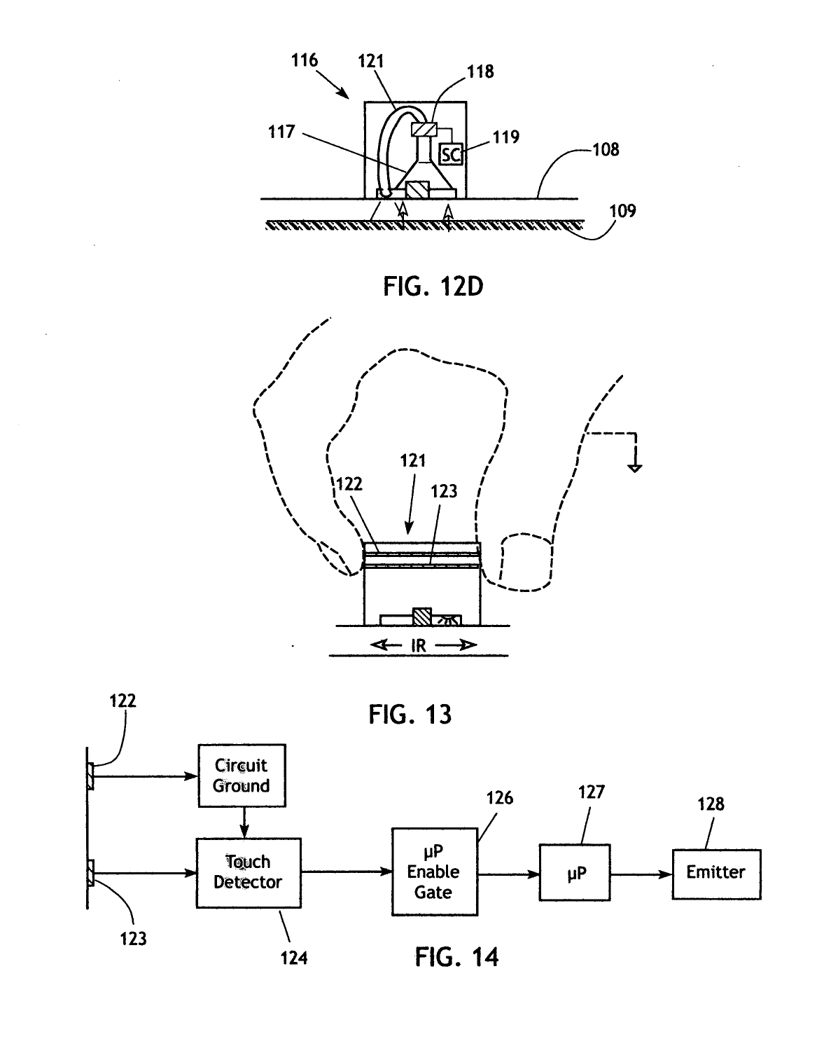

Another aspect of this invention is a touch sensitive circuit and method of operating a knob circuit so that human touch can reliably switch on the knob rather than use a mechanical switch that requires physical pressure to be actuated. With regard to FIG. 13, a knob 121 for use with the sensor pad of the invention described previously includes a pair of conductive rings 122 and 123 disposed in closely spaced relationship adjacent to the upper end of the knob 121. As shown in FIG. 14, ring 122 comprises a circuit ground, and ring 123 is connected to a touch detector 124. Contact by the user's finger on both rings completes a circuit with ground and causes a signal to be fed to microprocessor enable gate 126. Gate 126 in turn activates microprocessor 127 to deliver the proper PN code (or the like) to IR emitter 128, whereby the knob is activated and the position detection scheme described above is carried out.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiments described are selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A sensor pad assembly for detecting and tracking inputs to an electronic system, including:
a sensor pad having an upper surface and peripheral edges;
at least one input device adapted to interact with said sensor pad, said at least one input device having an emitter for outputting a first signal;
a plurality of sensors secured to said sensor pad and adapted to receive said first signal;
signal detection means for detecting said first signal and identifying said at least one device;
said signal detection means further determining the position of said at least one input device on said sensor pad and generating a corresponding position signal.

2. The sensor pad assembly of claim 1, wherein said sensor pad is adapted to extend across at least a portion of an electronic display screen, said sensor pad being transparent to visible light to permit visualization of said display screen, and further including means for said position signal to control the output of said display screen.

3. The sensor pad assembly of claim 1, wherein said first signal is an infrared signal, and said sensor pad is formed of a material that transmits and scatters infrared wavelengths.

4. The sensor pad assembly of claim 3, wherein said signal detection means includes a plurality of infrared sensors secured to said peripheral edges of said sensor pad and disposed to receive said infrared signal from said at least one input device.

5. The sensor pad assembly of claim 4, further including means for distinguishing said first signal from random ambient IR light incident on said sensor pad and said sensors.

6. The sensor pad assembly of claim 5, wherein said means for distinguishing including means for driving said emitter to emit said first signal with a PN code.

7. The sensor pad assembly of claim 6, wherein said means for driving said emitter includes a microprocessor operatively connected to said emitter and capable of storing and implementing said PN code.

8. The sensor pad assembly of claim 7, further including a trans-impedance amplifier connected between said microprocessor and said emitter.

9. The sensor pad assembly of claim 8, further including a plurality of said input devices, each having a respective unique PN code.

10. The sensor pad assembly of claim 9, wherein said plurality of sensors each produce a respective sensor signal, and further including means for deriving said PN code of each input device to identify each input device on said sensor pad.

11. The sensor pad assembly of claim 10, further including means for normalizing each of said respective sensor signals, and deriving said position signal of each input device by calculating the ratio of the respective normalized sensor signal of the sum of the sensor signals along each X and Y axis of the sensor pad.

12. The sensor pad assembly of claim 3, wherein said input device is a knob adapted to be rotated by a user.

13. The sensor pad assembly of claim 12, wherein said knob includes a post secured to outer surface of said sensor pad, and an infrared emitter spaced apart from said post and disposed to emit said first signal into said sensor pad.

14. The sensor pad assembly of claim 13, wherein said knob includes a peripheral skin concentric with said post and adapted to prevent ambient light from interfering with said first signal input to said sensor pad.

15. The sensor pad assembly of claim 13, further including means for preventing distortion of said first signal by said post.

16. The sensor pad assembly of claim 15, wherein said means for preventing distortion of said first signal includes said post comprised of a material transparent to said first signal, said post including a central bore extending axially therethrough to attenuate refraction of said first signal through said post.

17. The sensor pad assembly of claim 3, wherein said input device is powered by an internal battery.

18. The sensor pad assembly of claim 3, wherein said input device is powered by an electromagnetic field transmitted by said sensor pad, and further including means in said input device for receiving said electromagnetic field.

19. The sensor pad assembly of claim 18, wherein said means for receiving said electromagnetic field includes a coil adapted to resonate at the frequency of said electromagnetic field.

20. The sensor pad assembly of claim 18, wherein said sensor pad includes a transparent conductor formed on an outer surface of said sensor pad and connected to an electromagnetic field generator.

21. The sensor pad assembly of claim 20, wherein said transparent conductor is configured in a fractal pattern to distribute said electromagnetic field generally equally across said outer surface.

22. The sensor pad assembly of claim 20, wherein said transparent conductor is configured as a continuous layer extending across said upper surface of said sensor pad to produce a standing wave electromagnetic field.

23. The sensor pad assembly of claim 18, wherein said means for receiving said electromagnetic field includes an electrode for capacitively receiving said electromagnetic field.

24. The sensor pad assembly of claim 3, wherein said input device is powered by light emanating from said display screen.

25. The sensor pad assembly of claim 24, wherein said input device includes a photovoltaic device to receive said light from said display screen and power said emitter.

26. The sensor pad assembly of claim 25, wherein said input device further includes a rechargeable battery the receives the output from said photovoltaic device and powers said emitter.

27. The sensor pad assembly of claim 24, wherein said input device includes a light collector device for receiving said light emanating from said display screen, means for converting the collected light to infrared wavelengths, and means for directing said infrared wavelengths into said sensor pad.

28. The sensor pad assembly of claim 27, further including shutter means interposed between said means for converting the collected light and said sensor pad, said shutter means applying a PN code to the output of said means for converting.
